(19) United States
(12) Patent Application Publication
(10) Pub. No.: US 2024/0282502 A1
(43) Pub. Date: Aug. 22, 2024

(54) IRON CORE OF TRANSFORMER, AND MANUFACTURING METHOD THEREFOR

(71) Applicant: POSCO CO., LTD, Pohang-si, Gyeongsangbuk-do (KR)

(72) Inventor: Ho-Kyung Shim, Incheon (KR)

(73) Assignee: POSCO CO., LTD, Pohang-si, Gyeongsangbuk-do (KR)

(21) Appl. No.: 18/566,948

(22) PCT Filed: Jun. 9, 2022
(86) PCT No.: PCT/KR2022/008124

§ 371 Date: Dec. 4, 2023

(30) Foreign Application Priority Data
Jun. 9, 2021 (KR) 10-2021-0074504

(51) Int. Cl. H01F 27/245; H01F 41/02

(52) U.S. Cl. CPC H01F 27/245; H01F 41/0233

(57) ABSTRACT

The present invention relates to an iron core of a transformer having low no-load noise and a manufacturing method therefor, and the iron core of a transformer comprises: a pair of yokes, which are formed by stacking a plurality of electrical steel sheets and the pair of yokes are parallel to each other; and a leg, which is formed by stacking a plurality of electrical steel sheets, and the leg connects the pair of yokes, wherein, in a coupling part in which the yokes and the leg are connected, the ends of the electrical steel sheets of the yokes and the ends of the electrical steel sheets of the leg have inclined surfaces corresponding to each other, the inclined surfaces are shape-fitted, one electrical steel sheet of the yokes is stacked, through step lapping, on another electrical steel sheet of the yokes, and one electrical steel sheet of the leg can be stacked, through step lapping, on another electrical steel sheet of the leg.

### TECHNICAL FIELD

The present disclosure relates to an iron core of a transformer having low no-load loss and no-load noise and a manufacturing method thereof.

### BACKGROUND ART

A transformer is a device changing alternating-voltage and current values using electromagnetic induction, and is one of the essential components for electronic products. A transformer is manufactured by winding a coil, an electrical conductor, around a magnetic iron core. At this time, an electrical steel sheet with low magnetic loss is used as an iron core, and this iron core is divided into laminated iron core and wound iron core.

The main characteristics of transformers may include loss and noise, and in particular, no-load loss and no-load noise, which are power losses that occur every moment regardless of whether the transformer is used or not, are institutionally regulated. Accordingly, various methods for reducing no-load loss and no-load noise have been suggested. For example, Korean Patent Registration No. 1302830 discloses an example of a step lap iron core. In this technology, when forming the coupling portion of the iron core by stacking sheets of electrical steel, by stacking such that a spaced portion is created in a W shape in the thickness direction of the iron core, the structural rigidity of the iron core may be increased.

However, at the coupling portion of the iron core, the cut surface of each electrical steel sheet extends at right angles to the laminated surface of the electrical steel sheet to form a spaced portion stepped at right angles to other adjacent electrical steel sheets, and in order to fix the assembled state of the iron core, a hole penetrating through the iron core is required.

Since an air medium is present in the spaced portion and the hole and magnetic resistance is very high, a bottleneck phenomenon occurs in which the magnetic field is concentrated in an iron core region in which the spaced portion or the hole is not present. As a result, a high magnetic flux density is formed locally, and iron loss rapidly increases due to the characteristics of the electrical steel sheet. In addition, the holes have sufficient tolerances for easy assembly, thereby causing spacing and non-uniform alignment at the spaced portion.

In order to solve this problem, the applicant of the Republic of Korea Patent Registration No. 2109279 proposed a technique of applying and laminating an insulating adhesive on the upper and lower surfaces (laminated surfaces) of respective electrical steel sheets constituting the step lap iron core. This technology may reduce the no-load loss, but a phenomenon in which the no-load noise rapidly deteriorates occurs.

### SUMMARY OF INVENTION

### Technical Problem

Accordingly, an aspect of the present disclosure is to provide an iron core of a transformer with low no-load loss and no-load noise and a method of manufacturing the same.

### Solution to Problem

According to an aspect of the present disclosure, an iron core of a transformer includes a pair of yokes formed by stacking a plurality of electrical steel sheets and, the pair of yokes disposed to be parallel to each other; and a leg formed by stacking a plurality of electrical steel sheets, and the leg connects the pair of yokes, wherein, in a coupling portion in which the yoke and the leg are connected, an end of the electrical steel sheets of the yoke and an end of the electrical steel sheets of the leg have inclined surfaces corresponding to each other, and the inclined surfaces are shape-fitted, and wherein one electrical steel sheet of the yoke is laminated to another electrical steel sheet of the yoke in a step lap method, and wherein one electrical steel sheet of the leg is laminated to another electrical steel sheet of the leg in a step lap method.

According to an aspect of the present disclosure, a method of manufacturing an iron core of a transformer includes a step for preparing a plurality of electrical steel sheets and processing the electrical steel sheets into shapes of yoke and leg; a step for forming an iron core laminate by partially applying an insulating adhesive to the electrical steel sheets and laminating the electrical steel sheets; and a step for performing a heat treatment in a state in which pressure is applied to the iron core laminate, wherein the step for processing comprises forming an inclined surface by cutting or cutting or shearing ends of the electrical steel sheets at an angle, and wherein the step for forming of the iron core laminate is performed by laminating one electrical steel sheet of the yoke on another electrical steel sheet of the yoke in a step lap method and, by laminating one electrical steel sheet of the leg to another electrical steel sheet of the leg in a step lap method.

### Advantageous Effects of Invention

According to the present disclosure, the no-load loss of the transformer is lowered and the no-load noise is reduced, and thus the effect of improving the performance of the transformer may be obtained.

### BRIEF DESCRIPTION OF DRAWINGS

FIG. 1 is a perspective view illustrating an iron core of a transformer according to an embodiment of the present disclosure.

FIG. 2 provides views of a coupling portion of a step lap iron core viewed from the direction A in FIG. 1, in which (a) illustrates an iron core of the related art, and (b) and (c) illustrate the laminated state of electrical steel sheets in the iron core of the present disclosure.

FIG. 3 is a diagram illustrating an adhesive application area in an iron core of a transformer according to an embodiment of the present disclosure.

### BEST MODE FOR INVENTION

Among the coils of the transformer, the primary coil is connected to an input circuit whose voltage is to be changed, and the secondary coil is connected to an output circuit in which the changed voltage is used. In this case, magnetic energy is used to connect the electrical energy of the primary coil and the secondary coil to each other.

Depending on whether a power load connected to the secondary coil is used, it is divided into no-load characteristics and load characteristics. The no-load characteristic refers to the case in which there is no load, and always occurs constantly regardless of whether the transformer is operating, and power loss dissipated in the iron core is called no-load loss, and the noise generated at this time is called no-load noise.

On the other hand, the load characteristics occur when power is used in a load connected to the secondary coil, load loss is determined by Joule loss consumed in the coil, and load noise appears due to electromagnetic force between the coil and the iron core.

As a method of reducing no-load loss, an electrical steel sheet having low iron loss may be used as an iron core. Since iron loss increases as the thickness of the electrical steel sheet: increases, it is preferable to select an electrical steel sheet having a thickness as thin as possible.

No-load noise occurs when a magnetic field flows through an electrical steel sheet, causing a series of vibrations that repeat contraction and expansion (this is known as magnetostriction (magnetostriction)), and these vibrations cause vibrations and noise in the transformer.

In more detail, when a magnetic field is introduced from the outside of the electrical steel sheet, a series of contractions and expansions occur in a magnetic domain in a minute region within the base iron of the electrical steel sheet, but the cycle is not constant. Accordingly, vibration unique to each sheet of electrical steel in the laminated iron cores occurs differently.

In fact, since each sheet has a variety of vibration patterns, the vibration becomes very complicated. As a result, the period of vibrations is rapidly narrowed, in detail, the oscillation frequency is rapidly increased. In addition, harmonic vibrations occur in series and appear as fine vibrations.

As a result, when the vibration frequency increases and more harmonics occur, the noise is amplified and sounds very loud.

As described above, if the technology proposed by the present applicant for applying an insulating adhesive to the entire laminated surface of respective electrical steel sheets constituting the step lap iron core and then laminating and bonding the same is applied, although the no-load loss may be reduced, the no-load noise deteriorates rapidly.

If the adhesive is applied over the entire laminated surface, the flatness of the iron core is not maintained constant and bending occurs, and laminated iron cores are not evenly aligned and lifting occurs frequently.

The reason why the curvature occurs when the adhesive is applied over the entire laminated surface is due to the thickness variation of the electrical steel sheets. Rolling technology for precisely controlling the thickness of an electrical steel sheet has been gradually improved, but it is not possible to completely eliminate the variation in thin thickness. Accordingly, there is a deviation in the thickness of the electrical steel sheet within about 3 to 6%, and when the adhesive is applied to the entire laminated surface and laminated and bonded, bending inevitably occurs.

Due to this, the assembly is not smooth at the coupling portion of the step lap iron core, which becomes a major obstacle to the manufacture of the transformer and significantly lowers the manufacturing speed, that is, productivity. Moreover, the fastening state of the coupling portion is uneven, so the micro vibration becomes severe and the noise rapidly deteriorates.

Accordingly, the present applicant intends to propose the present disclosure by studying a method for reducing no-load noise as well as lowering no-load loss by identifying and improving the cause of rapidly deteriorating noise in the iron core of a transformer.

Hereinafter, the present disclosure is explained in detail through illustrative drawings. In adding reference numerals to the components of respective drawings, it should be noted that the same components have the same numerals as much as possible even if they are illustrated on different drawings.

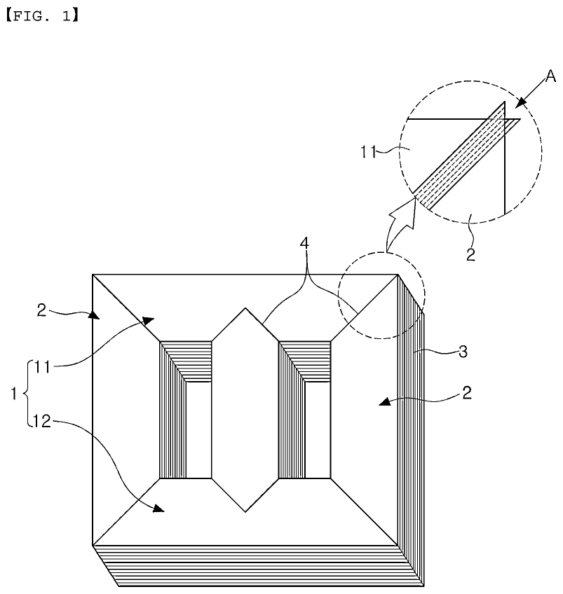

FIG. 1 is a perspective view illustrating an iron core of a transformer according to an embodiment of the present disclosure.

The iron core of a transformer according to an embodiment of the present disclosure includes an upper yoke 11, a lower yoke 12, and a plurality of legs 2 disposed between the upper yoke and the lower yoke and connecting the upper yoke and the lower yoke.

In this specification, the upper yoke 11 and the lower yoke 12 are selectively referred to as a yoke 1.

As a non-limiting example, the upper yoke 11 and/or the lower yoke 12 may be integrally formed with one of the plurality of legs 2.

The yoke 1 and the leg 2 are formed by stacking a plurality of electrical steel sheets 3, respectively. To this end, first, two or more electrical steel sheets are prepared, and each electrical steel sheet is processed into a cross-sectional shape of the yoke or leg of the iron core.

For example, after slitting the electrical steel sheets 3 to the width of the iron core of the transformer, the electrical steel sheet slit to an appropriate width is cut and punched to fit the shape of a coupling portion 4 of the iron core and may be cut into the shape of the yoke (1) and the leg (2).

As a result, the electrical steel sheet may be formed to have the same cross-sectional shape as the upper yoke 11, the lower yoke 12, and the plurality of legs 2.

The electrical steel sheet 3 used in the iron core of the transformer of the present disclosure is not particularly limited, and a grain-oriented electrical steel sheet or a non-oriented electrical steel sheet having a thickness of approximately 0.05 to 1.0 mm may be employed.

If the thickness of the electrical steel sheet 3 is as thin as less than 0.15 mm, iron loss is reduced but shape stability is deteriorated. On the other hand, if the thickness of the electrical steel sheet 3 exceeds 1.0 mm to be thick, iron loss increases. Considering these points, the thickness of the electrical steel sheet may be limited to approximately 0.05 to 1.0 mm.

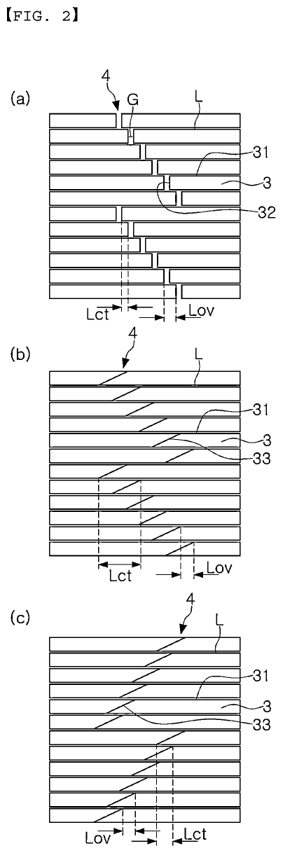

FIG. 2 is a view of the coupling portion of the step lap iron core viewed from the direction A in FIG. 1, in which (a) illustrates an iron core of the related art, and (b) and (c) illustrate the laminated state of electrical steel sheets in the iron core of the present disclosure.

(a) of FIG. 2 is a view illustrating a coupling portion of an iron core of the related art, and the ends are cut or sheared so that a cut surface 32 of each electrical steel sheet 3 extends at right angles to a laminated surface 31 of the electrical steel sheet.

The magnetic field has the property of flowing to the place where the magnetic resistance is the lowest. Magnetic resistance is inversely proportional to magnetic permeability, which is an indicator of how smoothly a magnetic field flows. Since the magnetic permeability of electrical steel sheet is hundreds to tens of thousands of times when air is assumed to be 1, when deviating from the electrical steel sheet, the magnetic resistance becomes very high.

The air gap (G) in which the electrical steel sheets face each other laterally is much wider than the gap between the electrical steel sheets stacked in the thickness direction of the electrical steel sheet 3, that is, the air layer (L). Accordingly, the magnetic resistance becomes larger in the air gap than in the air layer.

Due to this, when the magnetic field flowing in the single electrical steel sheet 3 reaches the air gap G, the magnetic field is dispersed and moved to the electrical steel sheet stacked above or below the corresponding electrical steel sheet through the air layer (L) having less magnetic resistance than the air gap.

Therefore, the magnetic field is concentrated in a contact area Lct illustrated in (a) of FIG. 2 and the magnetic flux density rapidly increases. In addition, the bottleneck phenomenon of the magnetic field generates a complex magnetic field containing various harmonics in the sine wave. The iron loss of the electrical steel sheet 3 increases as the magnetic flux density increases, and the iron loss increase amount increases rapidly when harmonics are included.

In this case, the contact area Lct may be defined as an area where an end of the electrical steel sheet of the yoke and an end of the electrical steel sheet of the leg contact and overlap each other in a path through which the magnetic field flows.

To solve this, in (a) of FIG. 2, the length of the contact area Lct may be extended, but in this case, the exposed portion exposed to the outside of the iron core from the coupling portion 4 of the iron core is increased by the length of a non-overlapping area Lov.

In this case, the non-overlapping area Lov may be defined as a region in which the position of either end of the electrical steel sheet of the yoke or the electrical steel sheet of the leg is changed based on the air gap G. The non-overlapping area may include an air gap.

The increase in the exposed portion creates a leakage magnetic field flowing out of the iron core, which is another factor that increases iron loss, and also results in deterioration of noise due to vibration of the exposed electrical steel sheet. For this reason, the method of increasing the length of the non-overlapping area Lov has limitations in application. For example, the length of the non-overlapping area Lov is usually managed at around 2 to 6 mm in the laminated iron core of a transformer.

Accordingly, in the iron core of the transformer according to an embodiment of the present disclosure, when cutting the electrical steel sheet 3 as illustrated in (b) and (c) of FIG. 2, in each electrical steel sheet, the end corresponding to the coupling portion 4 of the iron core is cut or cut obliquely to have a predetermined angle with respect to the laminated surface 31 of the electrical steel sheet unlike the related art, such that the end surface is formed to have an inclined surface 33.

The inclined surface 33 may be formed, for example, by grinding the ends corresponding to the coupling portion 4 of the iron core in the upper yoke 11, the lower yoke 12, and the plurality of legs 2. The inclined surfaces formed on the upper yoke and the leg or the lower yoke and the leg may be formed to be symmetrical to each other and disposed to correspond to each other to be shape-fitted.

In this manner, when the end of the electrical steel sheet 3 is formed to be inclined, the air gap G is minimized, so even if the same non-overlapping area Lov as in the related art is applied, the magnetic field distribution in the iron core flows more smoothly, reducing iron loss and reducing noise.

Subsequently, an insulating adhesive 5 is disposed to the inclined surface 33 of the cut electrical steel sheet 3 or around the inclined surface. When applying the adhesive, it is good to measure a certain amount and apply the same evenly so that it may be sufficiently disposed to the inclined surface or surroundings thereof.

As the adhesive 5, any adhesive capable of bonding electrical steel sheets to each other may be applied. Preferably, as an adhesive that may be used at high temperatures, for example, an epoxy adhesive or a ceramic adhesive having excellent insulating properties, or the like, may be used.

In the iron core of the transformer according to an embodiment of the present disclosure, the application method is not limited, but the application area of the adhesive 5 is confined to the vicinity of the coupling portion 4 of the iron core, that is, to the inclined surface 33 of each electrical steel sheet 3 or the vicinity thereof, and thus the occurrence of the above-mentioned curvature.

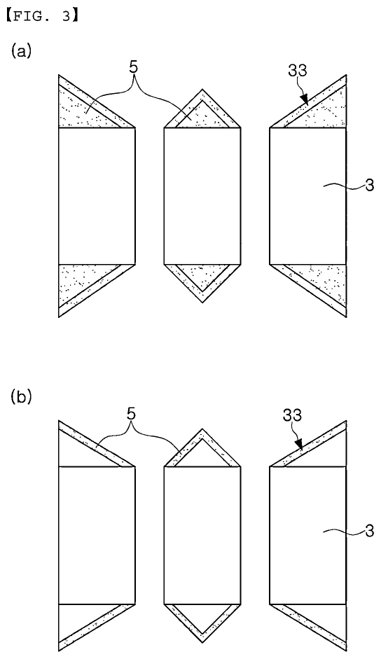

For example, the adhesive 5 may be applied to an area constituting a right triangle, with the diagonal of the coupling portion 4 as the hypotenuse, on the electrical steel sheet 3, as well as on the inclined surface 33. This example is illustrated in (a) of FIG. 3, and (b) of FIG. 3 illustrates an example in which the adhesive is disposed only to the inclined surface.

In this manner, in the iron core of the transformer according to an embodiment of the present disclosure, when applying the adhesive 5, the adhesive is not applied to the entire laminated surface of the electrical steel sheet as in the related art, and may be partially applied around the coupling portion 4 of the iron core as illustrated in (a) and (b) of FIG. 3, and thus the iron core may be fixed without occurrence of bending in the electrical steel sheet 3.

As a result, assembling is smoothly performed on the coupling portion 4 of the step lap iron core, and thus there are advantages of significantly improving manufacturing speed, that is, productivity, and reducing noise.

The adhesive 5 is disposed in an amount within about 0.2 to 5.0 g/mm². If the amount of adhesive is less than 0.2 g/mm², adhesive strength is weak, resulting in defects in iron core fixation. If it is more than 5.0 g/mm², the space factor of the iron core is lowered, which causes iron loss and noise to increase.

In this case, the space factor means the ratio occupied by the area of an effective part of a given space area, and in the present disclosure, means an effective area where a magnetic field is generated out of the total area of the electrical steel sheet constituting the iron core. In the space factor, when applied with an insulating material, the space factor decreases by the space occupied by the insulating material.

Next, the electrical steel sheet 3 may be stacked in a step lap method. Referring back to FIG. 2, one electrical steel sheet 3 of the yoke 1 is laminated on another electrical steel sheet of the yoke in the step lap method, and one electrical steel sheet 3 of the leg 2 may be laminated to another electrical steel sheet of the leg in a step lap method.

Ends of the electrical steel sheets 3 which are laminated to constitute the yoke 1 may be, for example, in an offset form repeating in a stair form or in a form in which inclined surfaces 33 of the ends are arranged in a misaligned manner.

Similarly, the ends of the electrical steel sheets 3 which are stacked to constitute the leg 2 may be, for example, in an offset form repeated in a stair form or in a form in which the inclined surfaces 33 of the ends are arranged in a misaligned manner.

FIG. 2 illustrates a step lap iron core in which a plurality of electrical steel sheets are stacked in 6 steps. This step lap method has excellent efficiency and low loss compared to other lamination methods (for example, miter lamination methods) applied to transformer iron cores.

The optimum number of steps in the step lap iron core may vary depending on the size and shape of the iron core, but the number of steps suitable for the laminated iron core of the transformer may be 3 to 10 steps, and in some cases, may be 4 to 7 steps.

As illustrated in (b) and (c) of FIG. 2, in the case of cutting or shearing obliquely by placing an inclined surface 33 of the electrical steel sheet 3 in the thickness direction and then laminating in a step lap method, as illustrated in (b) of FIG. 2, it is preferable to laminate in a direction in which the contact area Lct is enlarged. To this end, the electrical steel sheets may be stacked such that the length of the contact area Lct is at least longer than the length of the inclined surface 33 projected onto the laminated surface 31.

As illustrated in (c) of FIG. 2, when laminated in a direction in which the contact area Lct is reduced as illustrated in (c) of FIG. 2, in other words, when the electrical steel sheets are stacked so that the length of the contact area Lct is shorter than the length of the inclined surface 32 projected onto the laminated surface 31, iron loss and noise increase compared to the lamination of (b).

At this time, in the lamination of (b) and (c) of FIG. 2, the inclination angles of the inclined surfaces are the same and the lengths of the non-overlapping areas Lov are the same.

In lamination, an iron core laminate may be obtained by arranging electrical steel sheets 3 cut into yokes 1 and electrical steel sheets 3 cut into legs 2 according to the final shape of the iron core, and bonding and stacking the same.

However, it is not necessarily limited thereto, and for example, a yoke laminate is obtained by laminating electrical steel sheets 3 cut into yokes 1, and a leg laminate is obtained by laminating electrical steel sheets 3 cut into legs 2, and then, an iron core laminate may be obtained by assembling and bonding the yoke laminate and the leg laminate.

In the iron core of the transformer according to an embodiment of the present disclosure, a hole penetrating the iron core and a hole punching process for forming the hole to fix the assembled state of the iron core may be omitted. As described above, since the electrical steel sheet 3 is bonded with the insulating adhesive 5 without forming a hole, the iron core of the transformer according to an embodiment of the present disclosure may prevent damage to the magnetic properties of the electrical steel sheet caused by the hole.

However, since there is an advantage in that lamination of electrical steel sheets may be made easier in the case of forming holes, the formation of holes is not excluded from the scope of the present disclosure.

After that, to impart adhesive strength to the iron core laminate, both sides of the iron core laminate in the thickness direction are clamped with a clamp and pressed with a pressure within 0.01 to 0.8 MPa. If the pressing force is less than 0.01 MPa, the binding force of the iron core is weak, thereby causing separation when the transformer is operated for a long time. On the other hand, if it exceeds 0.8 MPa, the noise increases due to the compressive stress of the electrical steel sheet.

In addition, for the curing of the adhesive 5, the temperature of the iron core laminate is maintained within the range of 70 to 180° C. for at least 20 minutes or more. This heat treatment may be performed with any heater or oven, such as an induction or the like, for example.

For example, when a thermosetting resin adhesive is used as an adhesive, since the adhesive contains an epoxy or urethane component, it is not cured at less than 70° C., but the adhesive strength is weakened at a temperature exceeding 180° C.

Hereinafter, the present disclosure will be described in more detail through examples.

The no-load loss and no-load noise were compared after fabricating the iron cores of the transformers having the same weight by the manufacturing method of the related art and the manufacturing method of the present disclosure.

For example, in Table 1, as illustrated in FIG. 2, the characteristics of transformer cores fabricated by different cutting and lamination methods constituting the coupling portion of the iron core are compared. However, holes penetrating all the iron cores were formed and bolts were fastened to the holes to fix the iron cores.

In Comparative Example 1, the cut surface of each electrical steel sheet was formed to extend perpendicularly to the laminated surface of the electrical steel sheet, and the electrical steel sheets were laminated in the step lap method as in the related art.

Inventive Example 1 and Comparative Example 2, the end of the electrical steel sheet was formed to be inclined and to have an inclined surface according to the present disclosure, laminated in the same step lap method as in Comparative Example 1, and a bolt was fastened to the hole to fix the iron core.

Inventive Example 1 was configured as illustrated in (b) of FIG. 2, and Comparative Example 2 was configured as illustrated in (c) of FIG. 2. In other words, in Inventive Example 1, the lamination was performed in a direction in which the contact area (Lct) was enlarged, and in Comparative Example 2, the lamination was performed in a direction in which the contact area (Lct) was reduced.

Based on the no-load loss of Inventive Example 1, that is, Inventive Example 1 was taken as 100%, and the value of no-load noise was expressed in decibels (dBA), which is a log conversion value reflecting the audible response.

TABLE 1

| | Cutting and | | |
|---|---|---|---|
| | Laminating | No-load | No-load |
| Classification | Method | Loss | Noise |
| Comparative | (a) of FIG. 2 | 102.8% | 62.7 dBA |
| Example 1 | | | |
| Inventive | (b) of FIG. 2 | 100% | 60.8 dBA |
| Example 1 | | | |
| Comparative | (c) of FIG. 2 | 103.9% | 63.2 dBA |
| Example 2 | | | |

The reason for the excellent characteristics of Inventive Example 1 is that the bottleneck phenomenon of the magnetic field is alleviated by the inclined surface and the generation of harmonics is reduced.

Next, in Table 2, the characteristics of the iron cores of the transformer prepared by cutting and stacking in the same manner as in Inventive Example 1, but fixing with adhesive and varying the application area of adhesive and the pressing force of the clamp were compared.

In Comparative Example 3, an adhesive was disposed to the entire laminated surface of the electrical steel sheet, and heat treatment was performed by pressing a clamp at 5 MPa to minimize deformation of the iron core. When the pressing force was lowered, a springback phenomenon appeared and the fastening condition deteriorated, making it difficult to fix with a low pressing force. Heat treatment for hardening of the adhesive maintained the temperature of the iron core at 160° C. for 4 hours.

In Inventive example 2, as illustrated in (a) of FIG. 3, the adhesive was disposed to the inclined surface and the area constituting the right triangle therearound, and the temperature of the iron core was maintained at 160° C. for 1 hour while the clamp was pressed at 0.5 MPa to cure the adhesive.

In Inventive Example 3 and Comparative Example 4, as illustrated in (b) of FIG. 3, the adhesive was disposed to the inclined surface, and the temperature of the iron core was maintained at 160° C. for 1 hour while pressed with a clamp to cure the adhesive. However, in inventive example 3, it was pressed at 0.8 MPa, and in comparative example 4, the pressed pressure was increased to 0.9 MPa.

TABLE 2

| | Adhesive Application | No-load | No-load |
|---|---|---|---|
| Classification | Area and Pressing Force | Loss | Noise |
| Comparative | Entire laminated surface + | 96.3% | 68.9 dBA |
| Example 3 | 5 MPa | | |
| Inventive | (a) of FIG. 3 + 0.5 MPa | 96.2% | 57.2 dBA |
| Example 2 | | | |
| Inventive | (b) of FIG. 3 + 0.8 MPa | 96.1% | 56.1 dBA |
| Example 3 | | | |
| Comparative | (b) of FIG. 3 + 0.9 MPa | 96.2% | 62.2 dBA |
| Example 4 | | | |

Combining the characteristics of the iron core of the transformer by the related art manufacturing method and the manufacturing method of the present disclosure, in Comparative Example 3, the no-load loss is reduced by 3.7% compared to Inventive Example 1 by removing the hole penetrating the iron core and applying the adhesive to the entire laminated surface for bonding, but the no-load noise 10 was much worse than that of Inventive Example 1.

As in Inventive Examples 2 and 3, as the area to be bonded, in other words, the application area of the adhesive, is reduced, the tendency for noise to decrease was evident.

However, as in Comparative Example 4, when the pressing force was increased to more than 0.8 MPa, it was confirmed that the noise increased due to the compressive stress of the electrical steel sheet.

As described above, according to the present disclosure, holes penetrating the iron core may be eliminated, the air gap between the electrical steel sheets may be minimized, and at the same time, the flow of the magnetic field may be performed smoothly in the coupling portion of the iron core.

Therefore, the no-load loss of the transformer is lowered and the no-load noise is reduced, thereby obtaining an effect of improving performance of the transformer.

The above description is merely an example of the technical idea of the present disclosure, and various modifications and variations may be made to those skilled in the art without departing from the essential characteristics of the present disclosure.

Therefore, the embodiments disclosed in this specification and drawings are not intended to limit the technical idea of the present disclosure, but to explain, and the scope of the technical idea of the present disclosure is not limited by these examples. The protection scope of the present disclosure should be interpreted by the claims below, and all technical ideas within the equivalent range should be construed as being included in the scope of the present disclosure.

Description of Reference Characters

| | |
|---|---|
| 1: yoke | 2: leg |
| 3: electrical steel sheet | 4: coupling portion |
| 5: adhesive | 11: upper yoke |
| 12: lower yoke | 31: laminated surface |
| 32: cutting surface | 33: inclined surface |

1. An iron core of a transformer, comprising:
a pair of yokes formed by stacking a plurality of electrical steel sheets and, the pair of yokes disposed to be parallel to each other; and
a leg formed by stacking a plurality of electrical steel sheets, and the leg connects the pair of yokes,
wherein, in a coupling portion in which the yoke and the leg are connected, an end of the electrical steel sheets of the yoke and an end of the electrical steel sheets of the leg have inclined surfaces corresponding to each other, and the inclined surfaces are shape-fitted, and
wherein one electrical steel sheet of the yoke is laminated to another electrical steel sheet of the yoke in a step lap method, and
wherein one electrical steel sheet of the leg is laminated to another electrical steel sheet of the leg in a step lap method.

2. The iron core of a transformer according to claim 1, wherein, in the coupling portion, an insulating adhesive is disposed to the inclined surface of the electrical steel sheet or in a periphery of the inclined surface.

3. The iron core of a transformer according to claim 2, wherein the periphery of the inclined surface comprises a region constituting a right triangle with a diagonal of the coupling portion as a hypotenuse on the electrical steel sheet.

4. The iron core of a transformer according to claim 1, wherein the electrical steel sheets are stacked such that a length of a contact area in which the end of the electrical steel sheet of the yoke and the end of the electrical steel sheet of the leg contact and overlap is at least longer than a length of the inclined surface projected onto a laminated surface of the electrical steel sheets.

5. A method of manufacturing an iron core of a transformer, comprising:
a step for preparing a plurality of electrical steel sheets and processing the electrical steel sheets into shapes of yoke and leg;
a step for forming an iron core laminate by partially applying an insulating adhesive to the electrical steel sheets and laminating the electrical steel sheets; and
a step for performing a heat treatment in a state in which pressure is applied to the iron core laminate,
wherein the step for processing comprises forming an inclined surface by cutting or shearing ends of the electrical steel sheets at an angle, and
wherein the step for forming of the iron core laminate is performed by laminating one electrical steel sheet of the yoke on another electrical steel sheet of the yoke in a step lap method and, by laminating one electrical steel sheet of the leg to another electrical steel sheet of the leg in a step lap method.

6. The method of manufacturing an iron core of a transformer according to claim 5, wherein the adhesive is disposed to the inclined surface of the electrical steel sheet or on the periphery of the inclined surface.

7. The method of manufacturing an iron core of a transformer according to claim 6, wherein the adhesive is disposed in an amount ranging from 0.2 to 5.0 g/mm².

8. The method of manufacturing an iron core of a transformer according to claim 5, wherein the electrical steel sheets are stacked such that a length of a contact area in which an end of electrical steel sheet of the yoke and an end of electrical steel sheet of the leg contact and overlap is at least longer than a length of the inclined surface projected onto a laminated surface of the electrical steel sheets.

9. The method of manufacturing an iron core of a transformer according to claim 5, wherein the step for forming of the iron core laminate, the electrical steel sheet processed into a shape of the yoke and the electrical steel sheet processed into a shape of the leg are arranged according to a shape of the iron core, are bonded and stacked.

10. The method of manufacturing an iron core of a transformer according to claim 5, wherein the forming of the iron core laminate comprises,
a step for obtaining a yoke laminate by laminating the electrical steel sheets processed into the shape of the yoke;
a step for obtaining a leg laminate by laminating the electrical steel sheets processed into the shape of the leg; and
a step for assembling and bonding the yoke laminate and the leg laminate.

11. The method of manufacturing an iron core of a transformer according to claim 5, wherein the pressure is in a range of 0.01 to 0.8 MPa.

12. The method of manufacturing an iron core of a transformer according to claim 5, wherein in the heat treatment, a temperature of the iron core laminate is maintained within a range of 70 to 180° C. for at least 20 minutes or more.
